(19) United States
(12) Patent Application Publication
(10) Pub. No.: US 2012/0281694 A1
(43) Pub. Date: Nov. 8, 2012

(54) M2M SCALABLE ADDRESSING AND ROUTING

(75) Inventor: George Foti, Dollard des Ormeaux (CA)

(73) Assignee: TELEFONAKTIEBOLAGET L M ERICSSON (PUBL), Stockholm (SE)

(21) Appl. No.: 13/101,794

(22) Filed: May 5, 2011

(51) Int. Cl. H04L 12/56

(52) U.S. Cl. 370/389

(57) ABSTRACT

A novel routing and message handling mechanism allows a node to receive downstream packets addressed to an application server and modify the sender's contact address to include its own address. Thus, as the process is followed at each node in a hierarchy, the message is delivered to the application server with an address that specifies how to reach the particular node in question. When messages addressed to the node, or to applications resident on the node, are received by intervening nodes, the destination contact address can be modified by each node to ensure that they remove their own address as the message is passed along. In this way, no node needs to the topology of the connecting network, and no network application needs to know the topology of a potentially private delivery network.

### TECHNICAL FIELD

This disclosure relates generally to method of routing messages in Machine-to-Machine networks.

### BACKGROUND

Mobile data networks have typically arisen as overlays to cellular communication networks. As such, they often have many technical design features that arise as a result of maintaining compliance with legacy rules and standards. As mobile devices become more data-centric, some of these issues have become prominent. Addressing these issues is a delicate balance between solving issues in a technologically simple and straightforward manner and maintaining compatibility with existing systems.

At their inception, mobile data networks largely supported human operated devices, typically mobile phones and data cards used to connect laptops and other computing devices to the Internet. As a result, the vast majority of these connections were human controlled. As technology advances, and as the desire for a more connected world increases, there are an increasing number of devices using mobile data connections that are computer controlled and do not require human operation. These devices are typically referred to as machine-to-machine (M2M) devices, and or Machine Type Communication (MTC) devices.

M2M devices are often connected to sensors and meters to allow for a distributed collection of information without requiring human data collection. This often enables more granular data collection allowing for an increased variety of services and options to consumers.

As these devices begin to be deployed on mobile data networks, problems have arisen that cannot simply be addressed through a data-centric perspective. One such problem is that of addressing the devices, and keeping track of the location of the devices. For instance, if an M2M enabled meter is provided to a user, it is important that the device be able to be contacted by the network. Depending on the addressing scheme employed, the device may or may not be provided with a fixed IP address. The utility company who uses the meter may decide to change access providers, which would result in a new set of IP addresses for a large number of meters. Alternatively, the user may be movable, either by a technician or the user, and upon being moved, the device may have a different network address, but should still connect to the same account. There are a number of such scenarios in which simply relying upon an IP address is insufficient.

In many networks there is a desire for a central node to store sufficient information to reach all registered nodes and in many cases there is a desire for the central node to be able to determine a network topology. Typically this is done either through explicit network discovery procedures, or through the intervention of an administrator.

Conventionally, there are many different types of network addressing schemes, including hierarchical addressing. In a hierarchical addressing system, a node is identified by a multipart address, each part of the address providing information about the location of the device in the network. FIG. 1 provides an example of such a hierarchical addressing system, an international phone number 50 draw from the North American Number Pool. Such a phone number 50 contains a country code 52, an area code 54, an exchange 56 and an extension 58. As an example, phone number 50a has a country code 52a of ‘1’ which identifies that the phone number is part of the North American Numbering system. It has an area code 54a of ‘212’ indicating that it is a certain geographic area (in this case the area of New York City). It has an exchange 56a of ‘555’ and an extension 58a of ‘1234’. Typically the exchange provided information about a smaller geographic area while the extension was used by the exchange to know which line to ring. Thus from the perspective of any other phone on a connected network, the phone number 50a contains sufficient routing information for the individual line to be reached. Although a central routing node knows now to reach any given address, typically no phone in the network knows its own number, and when moved to a different location will not carry its number with it. Thus, the terminal device (the phone) does not carry any of its own addressing information.

Another example of a hierarchical addressing system is the somewhat ubiquitous IPv4 networking address as illustrated in FIG. 2. Each address 60 is composed of four segments, each referred to as an octet. As shown in FIG. 2, octet A 62, octet B 64, octet C 66 and octet D 68 are used in conjunction with each other, and are typically shown as decimal numbers separated by a period, also referred to as dotted decimal representation. Thus, an address 60a such as 192.168.100.010 has an octet A value 62a of ‘192’, an octet B value 64a of ‘168’, octet C value 66a of ‘100’ and octet D value 68a of ‘010’. As long as another device on the network has the address of a destination node, routing tables can be used to send packets to their correct destination. In comparison to the above described examples, in an IPv4 addressing scheme, very little geographic information is obtainable from an address, each node knows its own complete address, and each address contains sufficient information for any node in the network to send a message to the node associated with the address.

Another example is provided in FIG. 3 which shows a hierarchical addressing system used in computer operating systems based on Unix™. A peripheral device, such as a printer or storage device can be accessed by other computers using address 70 which has a server name 72, a system name 74 and a device name 76. In one example, a device can be accessed at name 70a, by referring to a server ‘sol’ 72a, a system ‘neptune’ 74a and a peripheral device ‘prn1’ 76a. In such a scenario, the terminal device typically does not communicate to other nodes and as such need not be provided with any naming information.

In other networking systems, there is a difference between public and private networks, as illustrated in FIG. 4. A public network 80 such as the Internet 82 is connected to a private network 86 through a gateway device 84. Gateway 84 has a public address 84a such as 10.0.0.1, and private address 84b such as 192.168.0.42. Devices (86a-86d) in private network 86 are assigned a set of addresses that are reachable only to the private network. If a device in the private network 86 such as device 86a wishes to communicate to a device in the public network 80, it sends packets to the gateway addressed to address 84b. As shown in FIG. 5, gateway 84 receives a packet from a private network node in step 88, modifies the header of the received packet to replace the originating address in the header with the public address 84a in step 90, and in step 92 transmits the modified packet to the destination in the public network.

FIG. 6 illustrates the general operation of the gateway upon receiving data from a node in the outside network. In step 94, the gateway receives a packet from the public network on a port. The gateway then replaces the destination address with a private network address associated with the port in step 96. In step 98, gateway 84 then forwards the packet to a node in the private network 86 in accordance with the replaced address.

In this example of the public-private gateway, addresses on the private network are completely opaque to a node on the public network, and there is no ability for anyone to determine network topology behind the opaque gateway.

None of the above solutions is particularly useful for a M2M network where there are a large number of devices, and it is often desirable for the entity that owns or controls the devices to be able to quickly determine the network topology associated with the routing of data to the device. Additionally, initialization of a new device on the network needs to be done in such a way that a centralized server is notified of the location, and the data connection path to the device. Using the above systems is both cumbersome and difficult.

Therefore, it would be desirable to provide a system and method that obviate or mitigate the above described problems

### SUMMARY

It is an object of the present invention to obviate or mitigate at least one disadvantage of the prior art.

In a first aspect of the present invention, there is provided a method of routing messages received by a first node in a network. The method comprises the steps of receiving, over a network interface of the first node, a message having an address field from a second node in the network, modifying an address in the address field in the message in accordance with an address associated with the first node, and transmitting the modified message to a third node in the network over a network interface.

In an embodiment of the first aspect of the present invention, the step of modifying includes modifying the address in the address field to include both the address in the address field as received by the first node and an address determined in accordance with the address of the first node. In a further embodiment, the address determined in accordance with the address of the first node corresponds to the address of the first node and the message is a registration message. The registration message can optionally be a message sent from a device to a machine to machine application server.

In a further embodiment of the first aspect, the address in the address field is associated with a network node at which the message originated. In some embodiments the address provides a routing path through which the network node at which the message originated can be reached.

In an alternate embodiment of the first aspect of the present invention, the step of modifying includes parsing the address field and removing a portion of the address in the address field as received by the first node, the portion determined in accordance with the address of the first node. In further embodiments, the portion of the address field determined in accordance with the address of the first node corresponds to the address of the first node and optionally, the address in the address field is associated with a network node to which the message is addressed. In other embodiments, the address provides a routing path through which the network node to which the message is addressed can be reached.

In a second aspect of the present invention, there is provided a method of routing a message at an intervening node received from a first downstream node and addressed to an upstream node. The method comprises receiving the message, over a network interface, from a second downstream node; modifying a sender contact address associated with the message to include a both the address as received with the message and an address associated with the intervening node; and transmitting the message with the modified sender contact address, over a network interface, towards the upstream node.

In embodiments of the second aspect of the present invention, the message is a registration message, and optionally the first downstream node and the second downstream node are one in the same. In further embodiments the step of modifying includes replacing the sender contact address as received with the message with a concatenation of the sender contact address as received with the message and the address of the intervening node.

In a third aspect of the present invention, there is provided a method of routing a message at an intervening node from an upstream node and having a destination address indicating a downstream node. The method comprises receiving the message, over a network interface, from the upstream node; modifying the destination address to remove a portion of the address associated with the current node; transmitting the message with the modified destination address, over a network interface, towards a downstream node.

In embodiments of the third aspect of the present invention, the step of modifying includes replacing the destination address with a new destination address corresponding to a portion of the destination address not associated with an address of the intervening node. In another embodiment, the step of receiving the message includes receiving the message from the upstream node through another node. In a further embodiment, the step of transmitting includes transmitting the message with the modified destination address to a node having an address corresponding to a portion of the modified destination address.

In a fourth aspect of the present invention, there is provided an intervening node for relaying messages between upstream and downstream nodes, and for modifying addresses associated with the relayed messages in accordance with an address associated with the intervening node. The intervening node comprises an upstream interface, a downstream interface, a packet analyzer and an address modifier. The upstream interface receives messages from, and transmits messages to upstream nodes. The downstream interface receives message from, and transmits messages to downstream nodes. The packet analyzer receives messages from the upstream and downstream interfaces, identifies destination and sender contact addresses associated with the received message, and selects one of the identified destination and sender contact addresses for modification. The address modifier modifies the selected address to replace the destination address with a new destination address corresponding to a portion of the identified destination address not associated with the address associated with the intervening node and for forwarding the message to an upstream node through the upstream interface when the selected address is the identified destination address and to replace the sender contact address with a new sender contact address corresponding to a combination of the identified sender address and the address associated with the intervening node

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram illustrating an exemplary hierarchical addressing scheme;

FIG. 2 is a block diagram illustrating an exemplary hierarchical addressing scheme;

FIG. 3 is a block diagram illustrating an exemplary hierarchical addressing scheme;

FIG. 4 is a block diagram illustrating an exemplary gateway dividing public and private networks;

FIG. 5 is a flow chart illustrating a method of routing packets between a node in a private network and a node in a public network;

FIG. 6 is a flow chart illustrating a method of routing packets between a node in a public network and a node in a private network;

FIG. 7 is an exemplary block diagram of an addressing scheme for a hierarchical network;

FIG. 8 is a flow chart illustrating an exemplary method of re-addressing messages;

FIG. 9 is a flow chart illustrating a modification to the method of FIG. 8;

FIG. 10 is a flow chart illustrating an exemplary method of re-addressing messages;

FIG. 11 is a flow chart illustrating a modification to the method of FIG. 10;

FIG. 12 is a flow chart illustrating an alternate modification to the method of FIG. 10;

FIG. 13 is a flow chart illustrating an exemplary method of re-addressing messages;

FIG. 14 is a block diagram illustrating an exemplary node for re-addressing and routing messages;

FIG. 15 is a message flow diagram illustrating an example of the transmission of a registration message from a device to an application server; and

FIG. 16 is a message flow diagram illustrating an example of the transmission of a message from a network application to a device through the application.

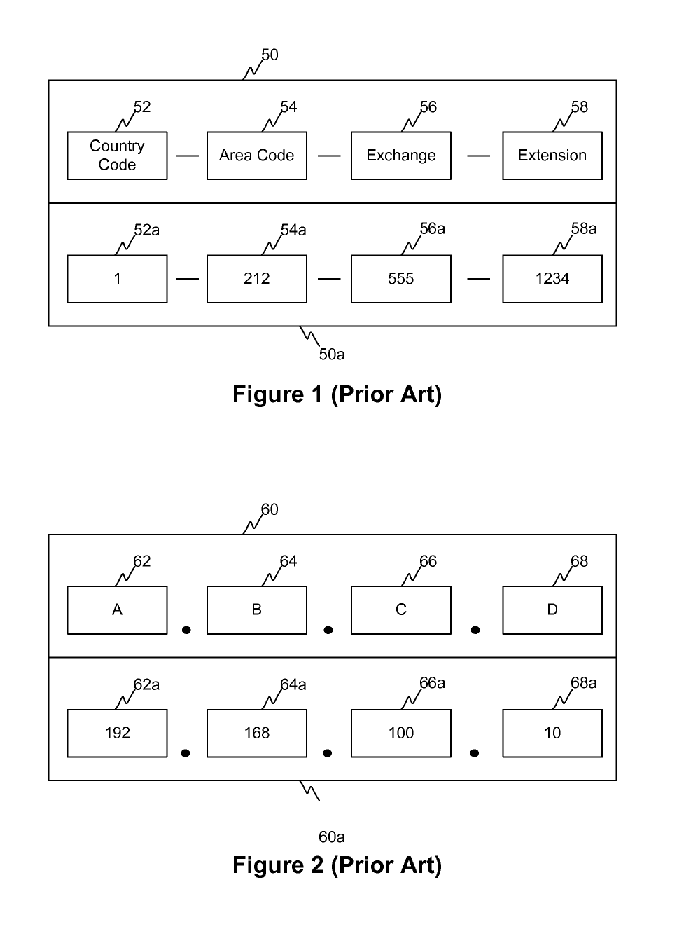

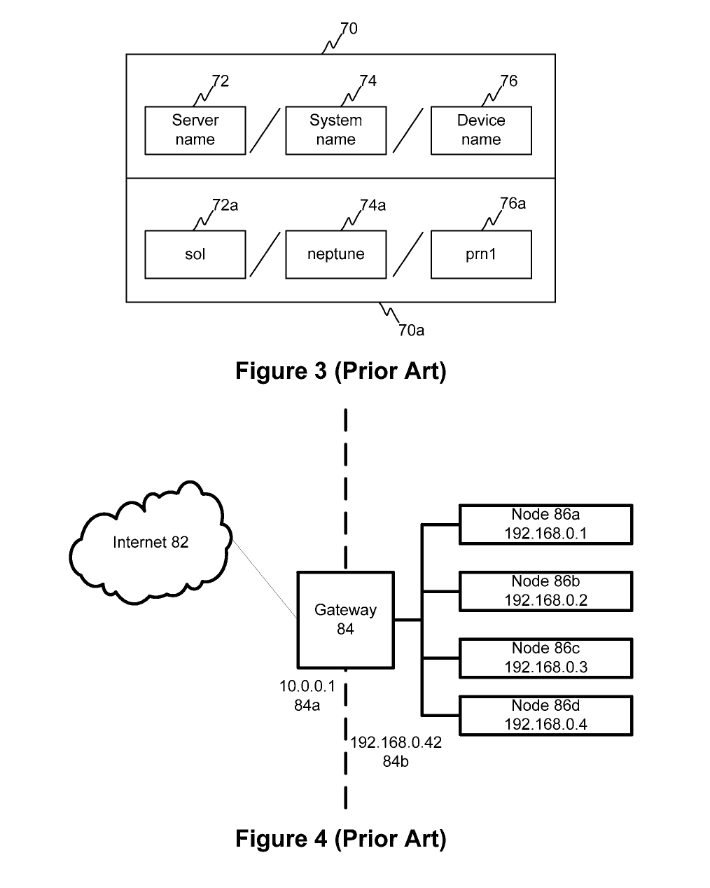

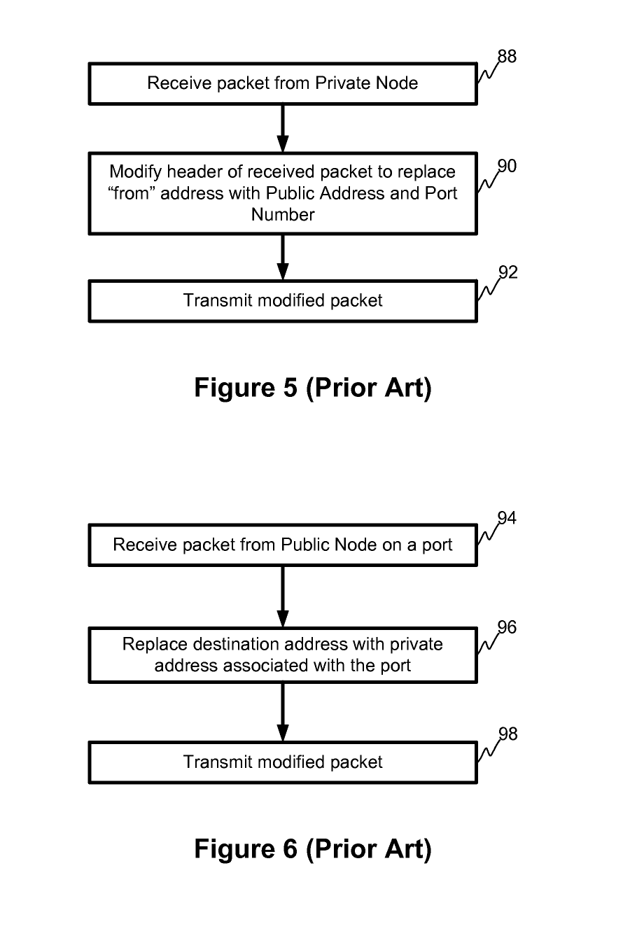

### DETAILED DESCRIPTION

The present invention is directed to a system and method for the routing and addressing messages in a machine-to-machine (M2M), also referred to as a Machine-Type-Communication, network.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

A hierarchical addressing system that allows for easy determination of topology, simplified configuration and easy routing will now be discussed. Some of the reduction of the complexity of this system is arrived at through a careful determination of the needs of the entity that owns or controls the M2M device, the network operators that provide the connectivity, and the needs of the M2M devices themselves.

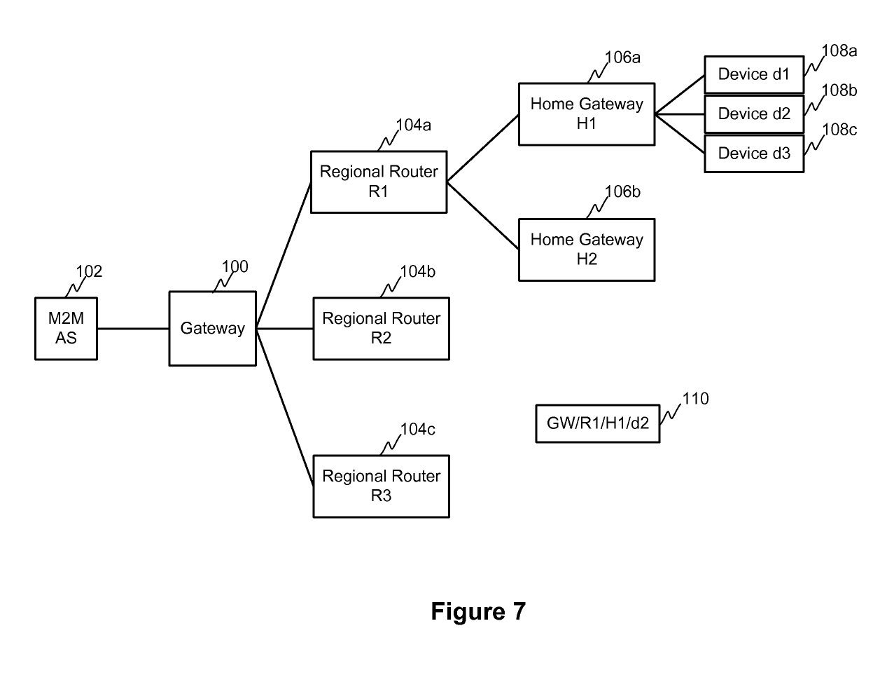

Unlike in a phone system, or a conventional computer network, there is rarely ever a need for a deployed M2M device to directly interact with another deployed M2M device. Instead the deployed devices are typically designed to relay information to a central system, often referred to as the M2M Application server (M2M AS). As shown in FIG. 7, an M2M AS 100 has a data connection to a gateway 100. Gateway 100 can be thought of as the start of a private network for M2M devices. Gateway 100 serves to connect and provide network connectivity for a series of regional access points 104 such as R1 104a, R2 104b and R3 104c. Each regional access point 104 can provide connectivity services to a plurality of home gateways 106 such as H1 106a and H2 106b. Each home gateway 106 can in turn provide connectivity services to a plurality of M2M devices 108 such as device d1 108a, device d2 108b and device d3 108c. In this architecture, each device knows its own name, and the name of the devices it is directly connected to. Thus, device d1 108a, knows that it is d1, and knows that it is connected to H1 106a. If it needs to send data to another node, such as M2M AS 102 it forwards the data to H1 106a. This information is typically pre-provisioned in the various devices or can be remotely configured through various means. Furthermore the names allocated to different devices in this hierarchal addressing system are preferably unique within a provider domain.

Similarly, H1 106a knows that it has downstream connections to devices 108a-108c, and that is has an upstream connection to R1 104a. R1 104a knows that it has a downstream connection to H1 106a and H2 106b, and an upstream connection to GW 100. GW 100 knows it has downstream connections to regional access points 104a-104c, and a connection upstream to M2M AS 102. One skilled in the art will appreciate that the manner in which each of the nodes is connected to another is not germane to this discussion, a collection of wired and wireless connections can be used and can be different between different devices. The full name 110 of a device in the network can be the result of a function of the path used to find the node in the network. In the cited example, the name of a device, such as device d2 108b is a concatenation of the nodes between the M2M AS 102 and the device, each node being separate by a ‘/’ to provide a name of GW/R1/H1/d2. This name is unambiguous, and much like a phone number includes all the information needed to both identify a node and all the information needed to route a message to the node.

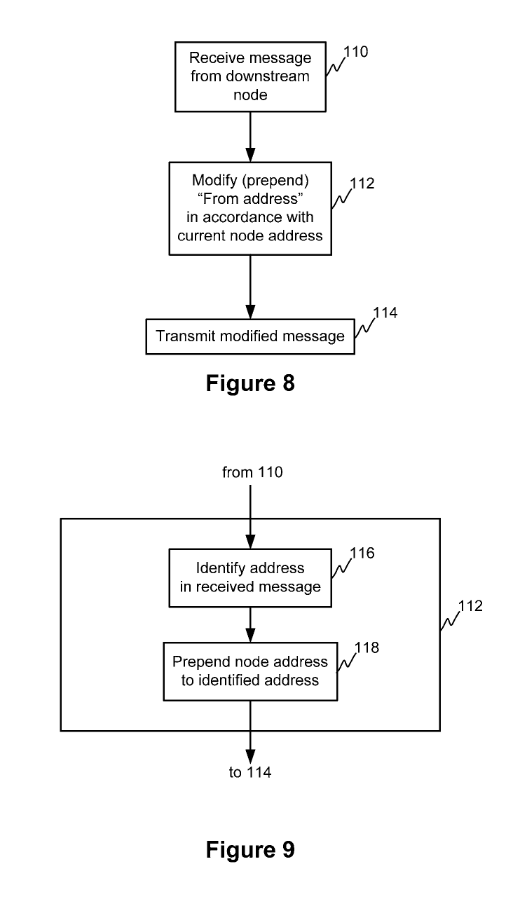

As each device knows both its upstream and downstream neighbors, the sending node need not directly know its full name in the network. Instead, when the sending node transmits a message, it identifies the intended destination (e.g. M2M AS 102) and provides as a sender address its own address. If the message is destined to a network node that the sender does not know how to reach, it can forward the message to its upstream node. When a node receives a message from a downstream node to be forwarded to an upstream node, it will modify the message as illustrated in FIG. 8. In step 110 a node receives a message from a downstream node. When this message is to be forwarded to an upstream node, the message is modified so that the sender address is changed by adding in information determined in accordance with the address of the node as shown in step 112. In step 114, the modified message is forwarded to the upstream node. As an example of how this can be performed, when node d3 108c sends a message to M2M AS 102, it addresses the message as being sent by d3, and forwards the message to H1 106a. H1 106a receives the message as shown in step 110, and then modifies the sender address by prepending its own address to the sender address. This results in step 112 where the sender address f d3 108c is replaced by H1/d3. The modified message is then forwarded to the next upstream node in step 114. When R1 104a receives the message it is addressed from H1/d3. R1 104a, will modify the message by prepending its own address to the sender address resulting in a new address of R1/H1/d3. In this way, when the message finally reaches the destination node, the entire path between the source node (the device) and the destination (the M2M AS) is contained in the sender address field of the message. Any node trying to send, or forward a message, to a downstream node simply needs to provide an address that includes the intervening nodes, as an example, R1 104a can forward a message to device d3 by simply sending the message to H1 106a, which in turn can forward the message to d3 108c.

When a device is newly provisioned, or is redeployed, it only needs to know the name of its upstream neighbor, and in an registration or initialization procedure can report its existence and location (address) to the M2M AS 102 by simply sending a first message. Upon receipt of a message from a terminal device, the M2M AS 102 will already have information about its location and network connection based on the name provided in the sender address. The M2M AS 102 will then use that same address to send information addressed to that device

FIG. 9 illustrates an exemplary modification to the method of FIG. 8. The step 112 of modifying the sender address is performed by identifying the sender address in step 116, and then pre-pending a node address to the sender address in step 118. One skilled in the art will appreciate that the step of identifying a sender address is commonly performed by identifying a sender address field as defined by a messaging standard.

In the above example, each node adds its own address to the sender field in the message. One skilled in the art will appreciate that in alternate embodiments, a node can modify the sender address in accordance with addressing information associated with the node, which may not be the node address. As an example, if node d1 108a knows that it is connected to node H1 106a, it may pre-address the message as being from H1/d1. Node H1 106a knowing it is connected to R1 104a would then modify the sender address to include the address of the next node in the chain, R1 104a, before forwarding the message. Alternately, the message could be send from device d1 108a to H1 106a without a sender address. H1 106a would recognize that it received the message from node d1 108a and add that information to the sender field before sending the message to R1 104a. R1 104a would then ensure that the sender address is modified to show H1/d1. As one can see from these examples, the hierarchical address is still built during transit of the message, and each node still modifies an address in the message in accordance with its own address

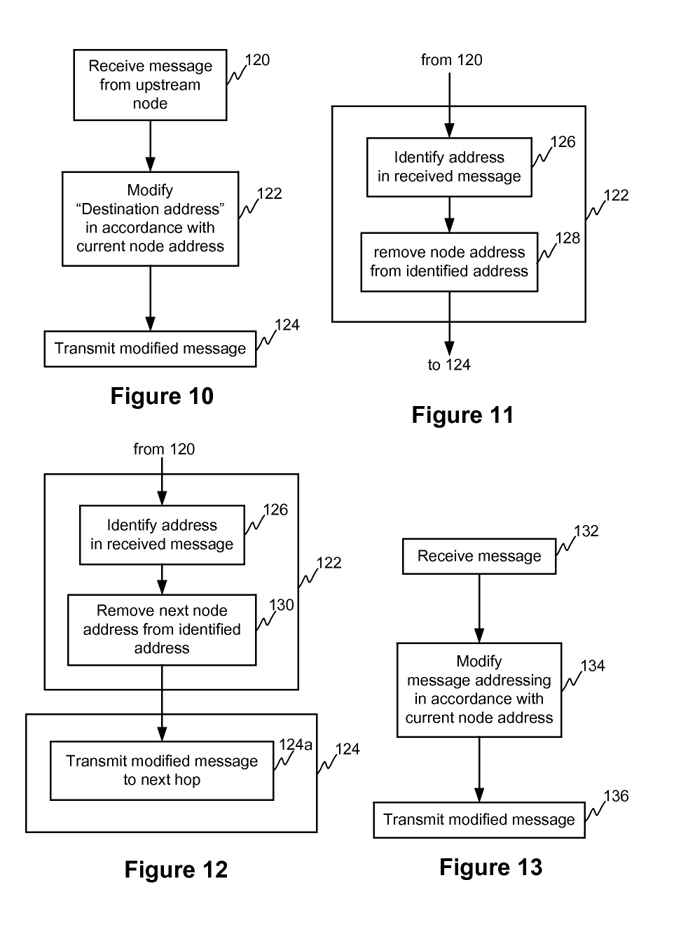

FIG. 10 illustrates a method of modifying a message received from an upstream node and using the full address of the device (received from the device in the incoming sender address information) for routing information towards the device. An M2M AS will address a message to a node using a notation such as GW/R1/H1/d2. This packet is then sent to a downstream node which is identified by parsing the destination address to isolate the first element (GW in the example). In step 120 a node receives a message from an upstream node. In step 122, the destination address of the received message is modified in accordance with the name (or address of the current node). In the present example, upon receiving a message addressed to GW/R1/H1/d2, gateway 100 will remove GW from the address. The modified message, now addressed to R1/H1/d2, is then sent to the next downstream node identified by the address (which can be identified as before by isolating the first element in the address) in step 124. In this case the downstream node is R1. Each successive downstream node then performs the same process until the message is received at node d2.

FIG. 11 illustrates an exemplary method of implementing step 122 of FIG. 10. In step 126, the destination address is identified in the message received from the upstream node. In step 128 the destination address is modified by the node removing its name from the address. The process then continues to step 124 as above.

In alternate embodiments, each node can modify the address of the message to remove the name of either the node that the message was received from, or to remove the name of the node that the message will be next transmitted to. FIG. 12 provides an exemplary example where a node will receive a message and remove the name of the next hop in the path instead of the current node name. In FIG. 12, step 122 of FIG. 10 is carried out by performing step 126 and step 130. As before, in step 126 the address field in the received message is identified. However in step 130, the address of the next node in the chain (the next hop on the path) is removed. Thus, gateway 100 would receive a message and modify the destination address so that it only showed H1/d2 (instead of R1/H1/d2 as shown in previous examples), and in step 124 (shown here as embodiment related step 124a) the modified packet would be forwarded to a node whose name has already been removed. In such an embodiment, it is recognized that any given node only needs to know who to forward the message to, and thus can remove that name from the address, and forward the message along.

One skilled in the art will appreciate that the methods outlined in FIGS. 8 and 10 can be generalized to a method shown in FIG. 13. In step 132, a message is received from a connected node. In step 134, the message (or a header to the message) is modified in accordance with the node address and the destination of the message. In step 136, the modified message is transmitted towards the destination. Thus, for a message originating at a downstream node (message going to M2M AS), the message is modified to add a node name to the sender address, and the message is forwarded to the next upstream node. Alternatively, a message originating at an upstream node (destined to a terminal device) is receive and the message is modified to remove a node name from the destination address and the message is then forwarded to the appropriate downstream node.

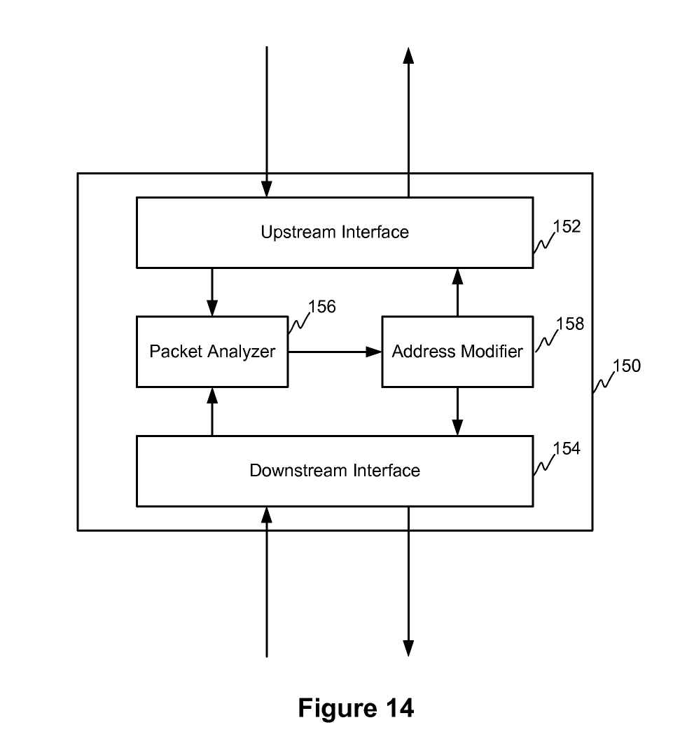

FIG. 14 is a block diagram illustrating an exemplary node for carrying out the methods described above. Node 150 has an upstream interface 152 for receiving messages from and transmitting messages to upstream nodes (those nodes topologically closer to the M2M AS). A downstream interface 154 carries out the equivalent function for downstream nodes (those closer to the terminal M2M devices). Messages received over either upstream interface 152 or downstream interface 154, are provided to packet analyzer 156 which identifies the sender and destination address, and forwards the message to the address modifier 158 with instructions to modify an address. If the message was received from the upstream interface, the packet analyzer 156 identifies the destination address, and the address modifier 158 removes a node name from the address and forwards the message to the downstream interface 154 to be sent to the next downstream node. If the message was received from the downstream interface 154, the packet analyzer 156 identifies the sender address and the address modifier adds a node name to the sender address. Typically, these packets are then sent to the upstream interface 152. One skilled in the art will appreciate that in some embodiments, after modifying the address, address modifier 158 route the modified message back to the analyzer 156 so that the analyzer can then determine which interface the message should be forwarded to. In such an embodiment, the analyzer 156 would have bi-directional communication channels with the upstream interface 152 and the downstream interface 154, and the address modifier 158 would not necessarily need the communication channels to the interfaces.

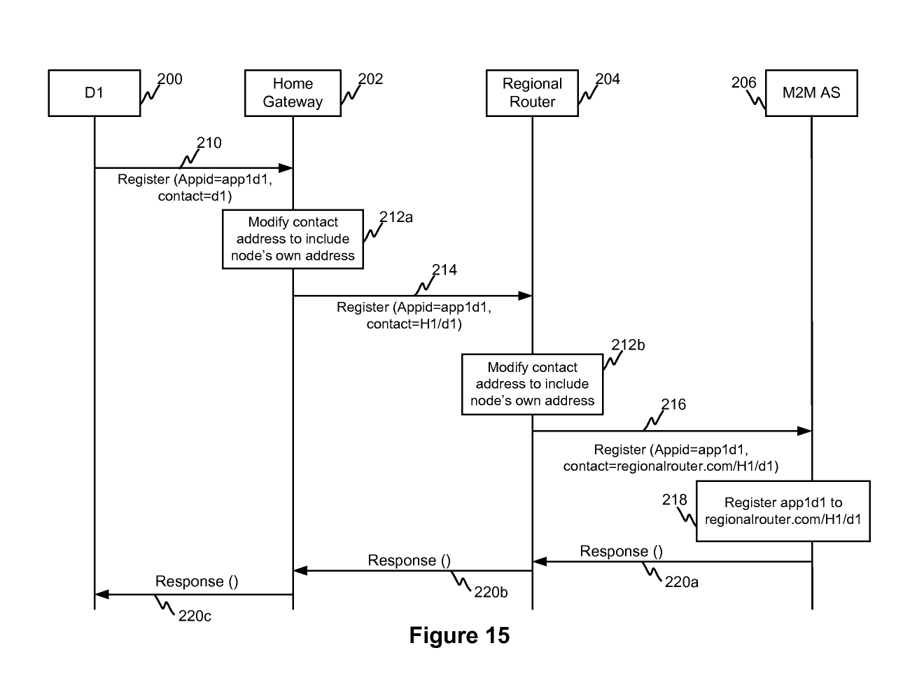

FIG. 15 provides an exemplary message flow diagram showing an embodiment of the present invention where the network topology has a device D1 connecting to a home gateway H1 202 and regional router 204, and then directly connecting to the Machine-to-Machine Application Server (M2M AS) 206. In this exemplary message flow, an application executed on device D1 200 is registered with M2M AS 206. In message 210, D1 200 transmits a request for registration that indicates the Application Identified (AppID) as app1d1, and indicates that the contact node is d1 200. Thus, this application can be reached by messages sent to device D1 200 that specify that they are intended for Application app1d1. This message 210 is received by Home Gateway H1 202. Upon receipt of message 210, H1 202 modifies the contact address in step 212a to include its own address using a method such as those discussed earlier. H1 202 then transmits the modified registration request as message 214. Message 214 is requesting the registration of app1d1, and specifies a contact of H1/d1 as H1 200 has modified the address to include its own address. Message 214 is transmitted to the Regional Router 204, which in step 212b modifies the contact address to include its own address. The resulting message 216 is sent to the M2M AS 206, and is requesting registration of application app1d1 which can be contacted at regionalrouter.com/H1/d1. One skilled in the art will appreciate that the use of regionalrouter.com as a domain name is not to be construed as limiting. In step 218, M2M AS 206 registers app1d1 and records its contact address as regionalrouter.com/H1/d1. Thus, when an application wants to engage app1d1, the M2M AS 106 will know to access it through D1 200, and will know how to route messages to app1d1 when needed. In response to the registration, a response message 220a is sent to Regional Router 204, which in turn sends response message 220b to the home gateway 202, which in turn provides a response message 220c to the device D1 200.

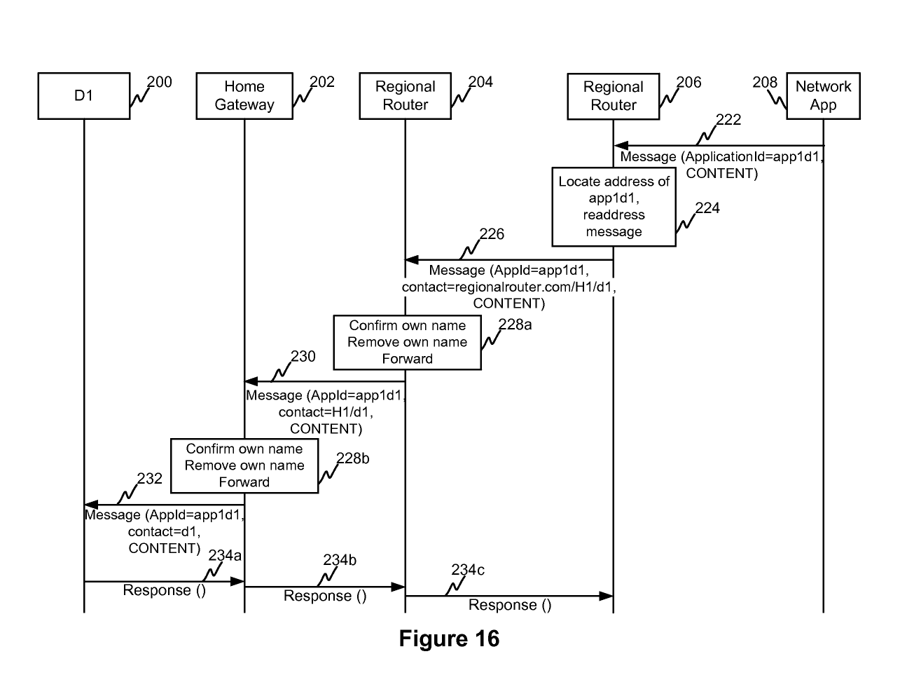

After a registration of a device (or an application running on a device) as shown in FIG. 15, it is common that an application in the network will want to send a message to the application on the device. FIG. 16 shows the message flow for one such scenario. As before nodes D1 200, home gateway 202, regional router 204 and M2M AS 206 communicate to each other in series. In this example, a network application 208 is introduced. Network Application 208 sends a message 222 to M2M AS 106 that indicates the application identifier (ApplicationId or AppId) app1d1 and contains content intended for the application. This content can be data to be used by the application, or could be instructions for the application to do a defined task. One skilled in the art will appreciate that there are a wide variety of different uses for the content. In step 224, the M2M AS 206 determines the address of the device on which app1d1 is registered, and re-addresses the message. Re-addressed message 226 is addressed to regionalrouter.comH1/d1, and is then forwarded to Regional Router 204. Regional Router 204 then processes the message in 228a according to the methods discussed above. The message processing allows regional router 204 to identify its address in the message, and then remove its address and forward the address to the next identified node. Re-addressed message is sent to Home Gateway 202 with the contact value set to H1/d1. Home Gateway 202 then processes the message in 228b, where it identifies its own address in the message, removes its address and forwards the message, as message 232 to device D1 200. Message 232 still indicates that the application identifier is app1d1, but is now only addressed to d1. As such device D1 200 can provide the message to the resident application app1d1. Upon receipt of the message, device D1 200 can send response 234a to the home gateway 202, which in turn can send response 234b to the regional router 204, which then forwards response 234c to the M2M AS 206.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of routing messages received by a first node in a network, the method comprising:
receiving, over a network interface of the first node, a message having an address field from a second node in the network;
modifying an address in the address field in the message in accordance with an address associated with the first node; and
transmitting the modified message to a third node in the network over a network interface.

2. The method of claim 1 wherein the step of modifying includes modifying the address in the address field to include both the address in the address field as received by the first node and an address determined in accordance with the address of the first node.

3. The method of claim 2 wherein the address determined in accordance with the address of the first node corresponds to the address of the first node.

4. The method of claim 2 wherein the message is a registration message.

5. The method of claim 4 wherein the message is sent from a device to a machine to machine application server.

6. The method of claim 2 wherein the address in the address field is associated with a network node at which the message originated.

7. The method of claim 6 wherein the address provides a routing path through which the network node at which the message originated can be reached.

8. The method of claim 1 wherein the step of modifying includes parsing the address field and removing a portion of the address in the address field as received by the first node, the portion determined in accordance with the address of the first node.

9. The method of claim 8 wherein the portion of the address field determined in accordance with the address of the first node corresponds to the address of the first node.

10. The method of claim 9 wherein the address in the address field is associated with a network node to which the message is addressed.

11. The method of claim 10 wherein the address provides a routing path through which the network node to which the message is addressed can be reached.

12. A method of routing a message at an intervening node received from a first downstream node and addressed to an upstream node, the method comprising:
receiving the message, over a network interface, from a second downstream node;
modifying a sender contact address associated with the message to include a both the address as received with the message and an address associated with the intervening node; and
transmitting the message with the modified sender contact address, over a network interface, towards the upstream node.

13. The method of claim 12 wherein the message is a registration message.

14. The method of claim 12 wherein the first downstream node and the second downstream node are one in the same.

15. The method of claim 12 wherein the step of modifying includes replacing the sender contact address as received with the message with a concatenation of the sender contact address as received with the message and the address of the intervening node.

16. A method of routing a message at an intervening node from an upstream node and having a destination address indicating a downstream node, the method comprising:
receiving the message, over a network interface, from the upstream node;
modifying the destination address to remove a portion of the address associated with the current node; and
transmitting the message with the modified destination address, over a network interface, towards a downstream node.

17. The method of claim 16 wherein the step of modifying includes:
replacing the destination address with a new destination address corresponding to a portion of the destination address not associated with an address of the intervening node.

18. The method of claim 16 wherein the step of receiving the message includes receiving the message from the upstream node through another node.

19. The method of claim 16 wherein the step of transmitting includes transmitting the message with the modified destination address to a node having an address corresponding to a portion of the modified destination address.

20. An intervening node for relaying messages between upstream and downstream nodes, and for modifying addresses associated with the relayed messages in accordance with an address associated with the intervening node, the intervening node comprising:
an upstream interface for receiving messages from, and transmitting messages to upstream nodes;
a downstream interface for receiving message from, and transmitting messages to downstream nodes;
a packet analyzer for receiving messages from the upstream and downstream interfaces, for identifying destination and sender contact addresses associated with the received message, and for selecting one of the identified destination and sender contact addresses for modification; and
an address modifier for modifying the selected address to:
replace the destination address with a new destination address corresponding to a portion of the identified destination address not associated with the address associated with the intervening node and for forwarding the message to an upstream node through the upstream interface when the selected address is the identified destination address; and
replace the sender contact address with a new sender contact address corresponding to a combination of the identified sender address and the address associated with the intervening node.
